(19) United States
(12) Patent Application Publication
(10) Pub. No.: US 2017/0208996 A1
(43) Pub. Date: Jul. 27, 2017

(54) TOASTER

(71) Applicant: TOP ELECTRIC APPLIANCES INDUSTRIAL LIMITED, Guangzhou (CN)

(72) Inventors: Weizhong Li, Guangzhou (CN); Yewu Zhong, Guangzhou (CN)

(21) Appl. No.: 15/326,935

(22) PCT Filed: Jan. 27, 2015
(86) PCT No.: PCT/CN2015/071657

§ 371 Date: Jan. 17, 2017

(51) Int. Cl. A47J 37/08

(52) U.S. Cl. CPC A47J 37/08

(57) ABSTRACT

A toaster is provided that can include a chamber for receiving and accommodating a food item. The toaster can also include a heating member for generating heat to toast the food item. The toaster can also include a control means for controlling air flow in the chamber. Control of the air flow with the control means can improve heat transfer of the generated heat onto the food item.

### TECHNICAL FIELD

This invention relates to an electrical appliance for heating a food item, and particularly, but not exclusively, to an electrical appliance for toasting a food item.

### BACKGROUND ART

Electric toasters are popular home appliances, and particularly in western countries such as the United States and in Europe, toasters are so commonly used that most family would have at least one in their kitchen. Toasters of various designs and functions have been developed, with conventional toasters generally comprise heating elements for generating heat to toast the bread surfaces. Nevertheless, the generated heat, in most circumstances, is to be distributed in a random manner and therefore, a large amount of the heat would be dissipated to the environment or other parts of the toaster and thus wasted.

### DISCLOSURE OF INVENTION

### Technical Problem

An object of the present invention is to provide a toaster in which the aforesaid shortcoming is mitigated or at least to provide a useful alternative.

The above object is met by the combination of features of the main claims; the sub-claims disclose further advantageous embodiments of the invention.

One skilled in the art will derive from the following description other objects of the invention. Therefore, the foregoing statement of object is not exhaustive but serves merely to illustrate some of the many objects of the present invention.

### Solution to Problem

### Technical Solution

In one main aspect of the present invention, it provides a toaster comprising a chamber for receiving and accommodating a food item, a heating member for generating heat to toast the food item, and a control means for controlling air flow in the chamber to improve heat transfer onto the food item.

The invention is advantageous in that it provides a toaster which enables an improved heat transfer by directing, guiding or focusing the air flow which carries along the generated heat from the heating member onto the food item to be toasted, thereby improving the efficiency of the toaster. The toaster of the present invention allows toasting of the food item in a more controlled manner, thereby enabling the toasting be completed in a shorter period of time, and thus, with less energy consumption.

The summary of the invention does not necessarily disclose all the features essential for defining the invention; the invention may reside in a sub-combination of the disclosed features.

### BRIEF DESCRIPTION OF DRAWINGS

### Description of Drawings

The foregoing and further features of the present invention will be apparent from the following description of preferred embodiments which are provided by way of example only in connection with the accompanying figures, of which:

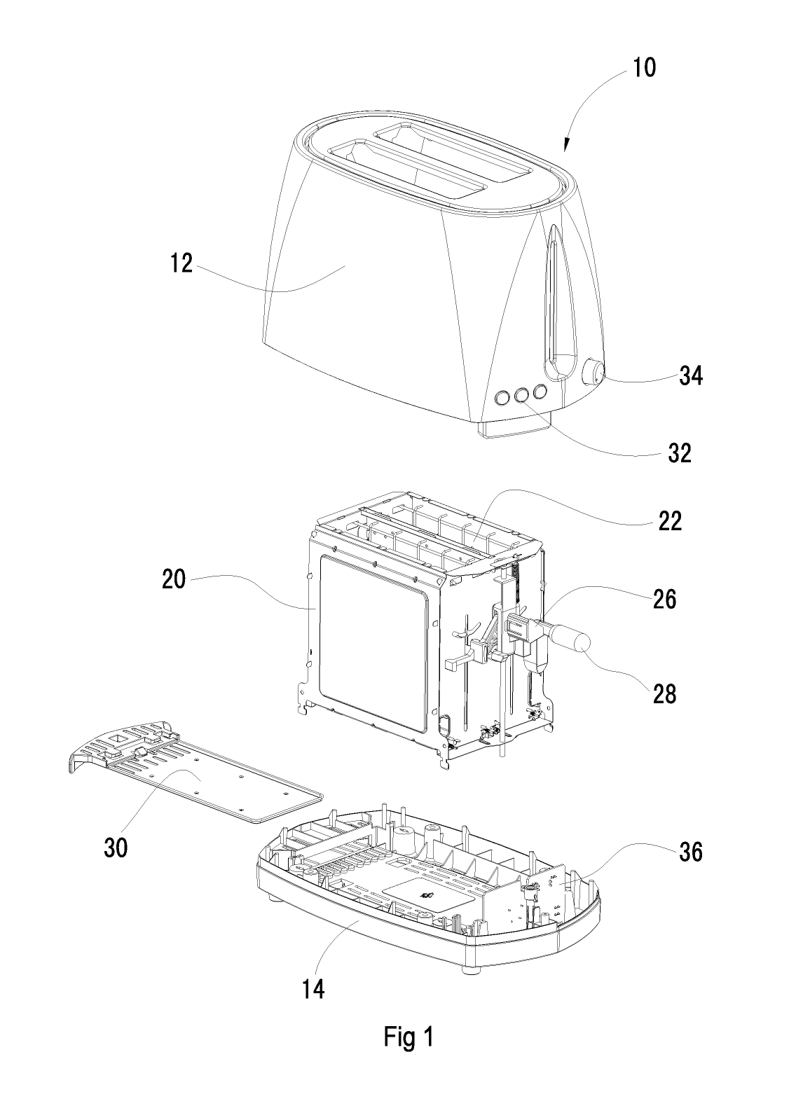

FIG. 1 is an exploded view of a first embodiment of the present invention showing the internal structures of the embodied toaster;

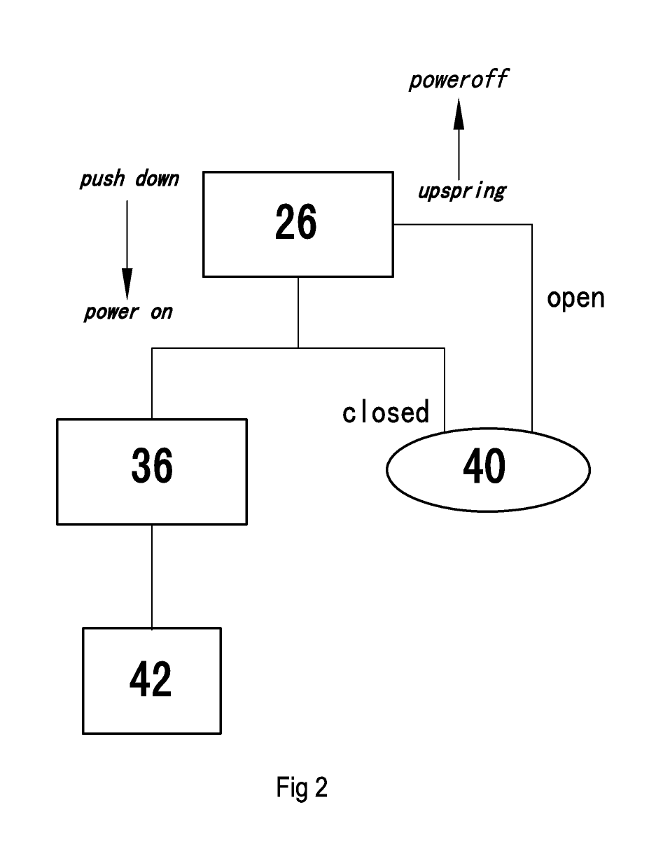

FIG. 2 is a block diagram showing the basic operations of the toaster of FIG. 1;

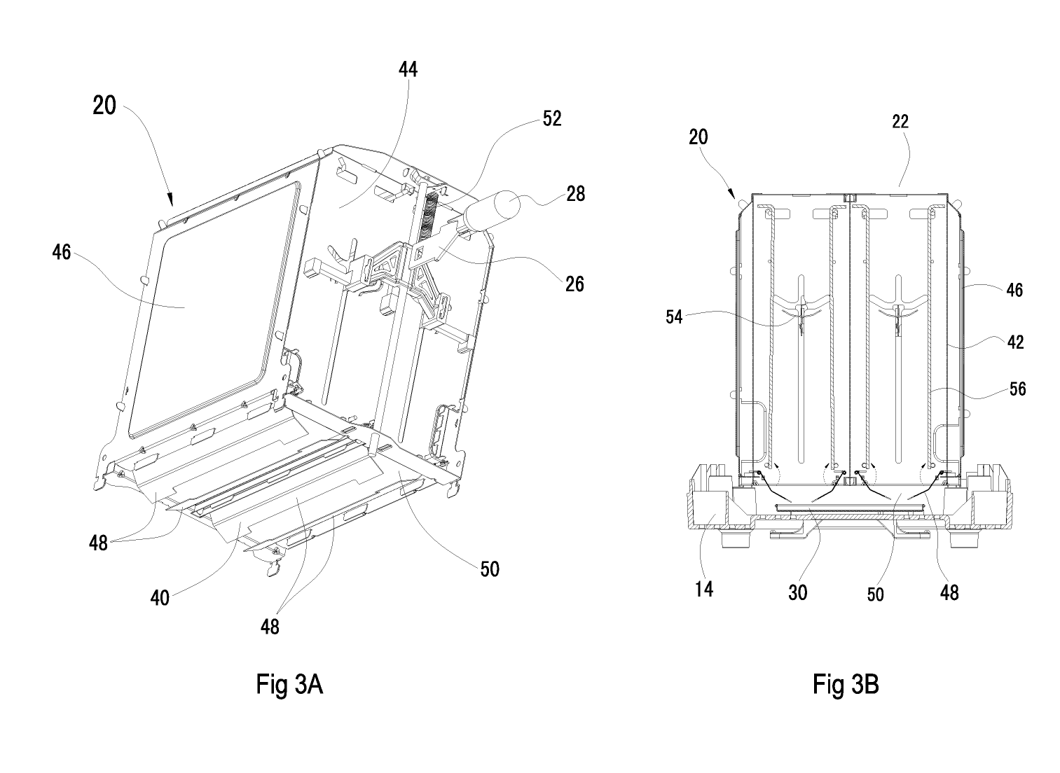

FIG. 3A is a perspective view showing the toasting unit of FIG. 1 prior to the loading of a food item;

FIG. 3B is a front cross-sectional view showing the toasting unit of FIG. 1 prior to the loading of the food item;

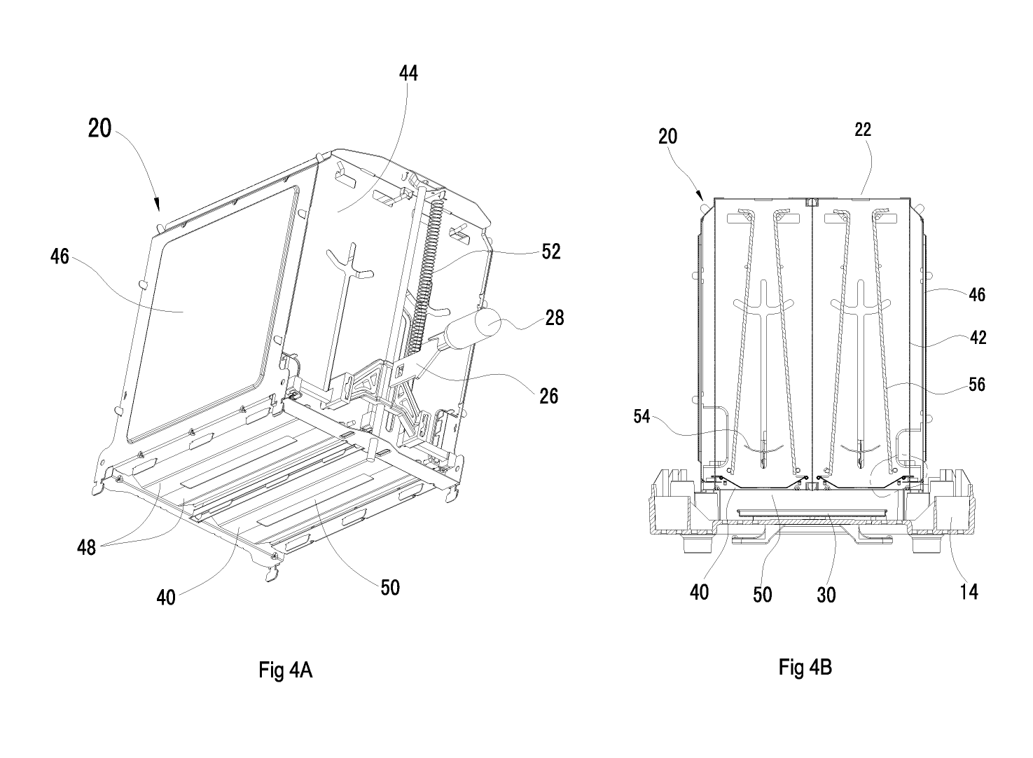

FIG. 4A is a perspective view showing the toasting unit of FIG. 3A after loading of the food item (not shown);

FIG. 4B is a front cross-sectional view showing the toasting unit of FIG. 3B after loading of the food item (not shown);

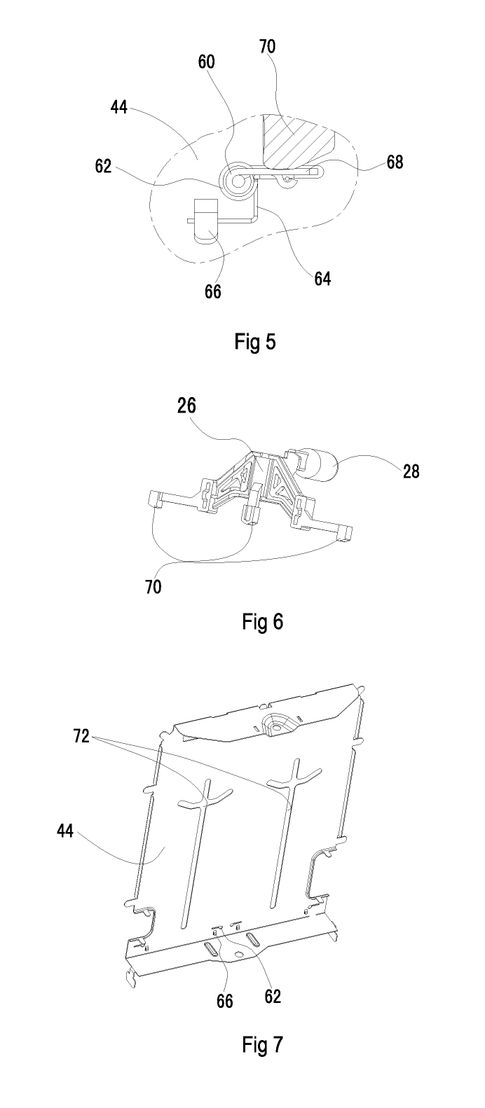

FIG. 5 is a magnified front view of a connection arrangement of the toasting unit as shown in FIGS. 3A, 3B, 4A and 4B;

FIG. 6 is a perspective view of a loading means of the toasting unit as shown in FIGS. 3A and 4A;

FIG. 7 is a perspective view of a front panel of the toasting unit as shown in FIGS. 3A and 4A;

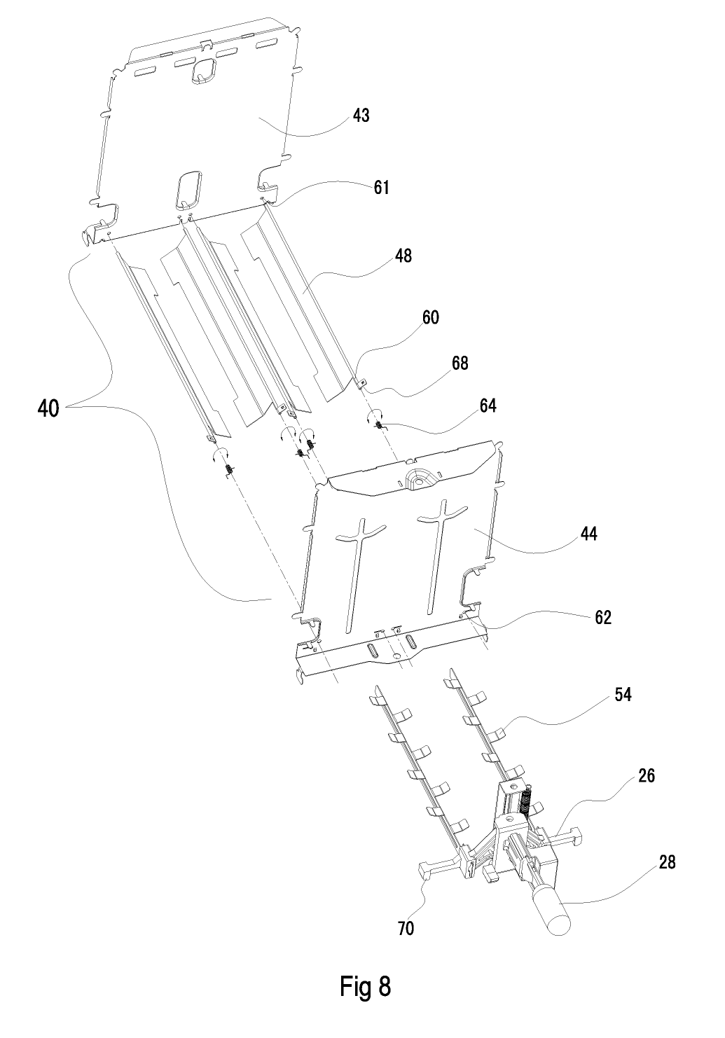

FIG. 8 is an exploded view showing the internal structures of the toasting unit as shown in FIGS. 3A and 4A;

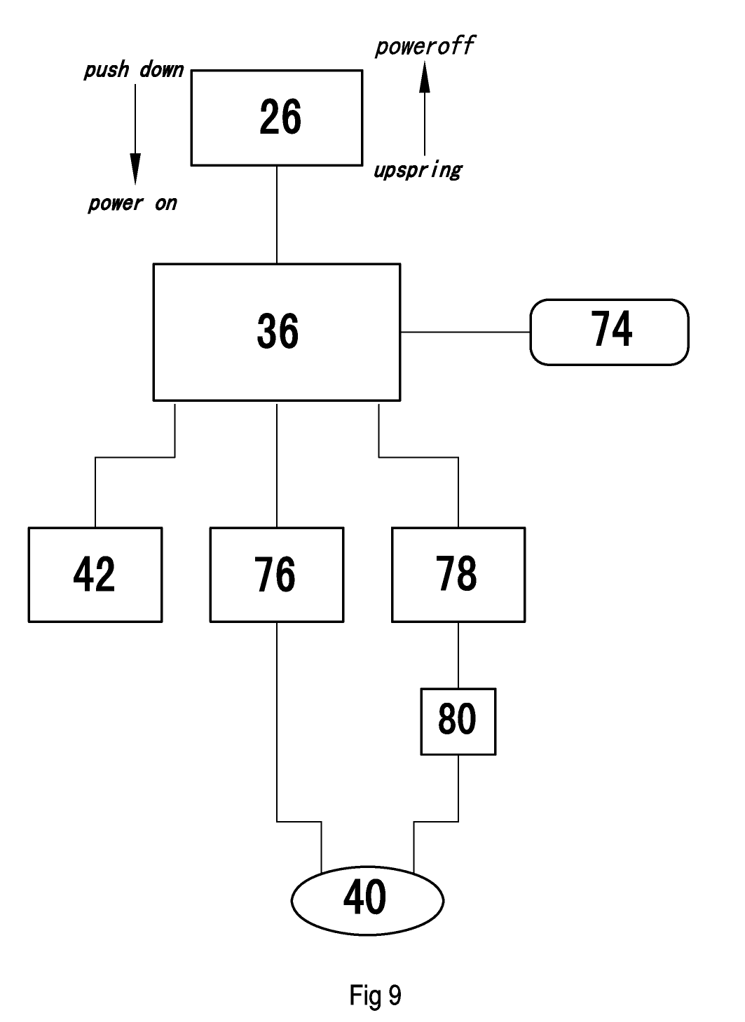

FIG. 9 is a block diagram showing the basic operations of a second and a third embodiments of the present invention;

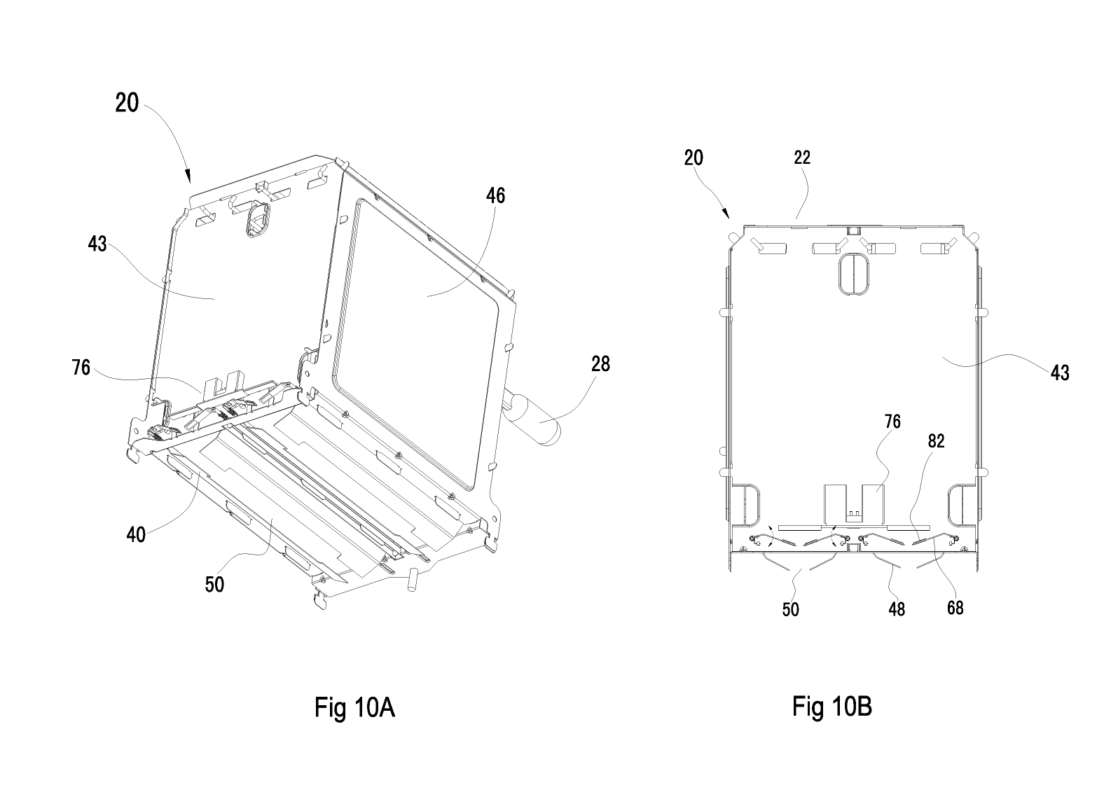

FIG. 10A is a perspective view showing the toasting unit of the second embodiment of FIG. 9 prior to the loading of the food item;

FIG. 10B is a rear view showing the toasting unit of the second embodiment of

FIG. 9 prior to the loading of the food item;

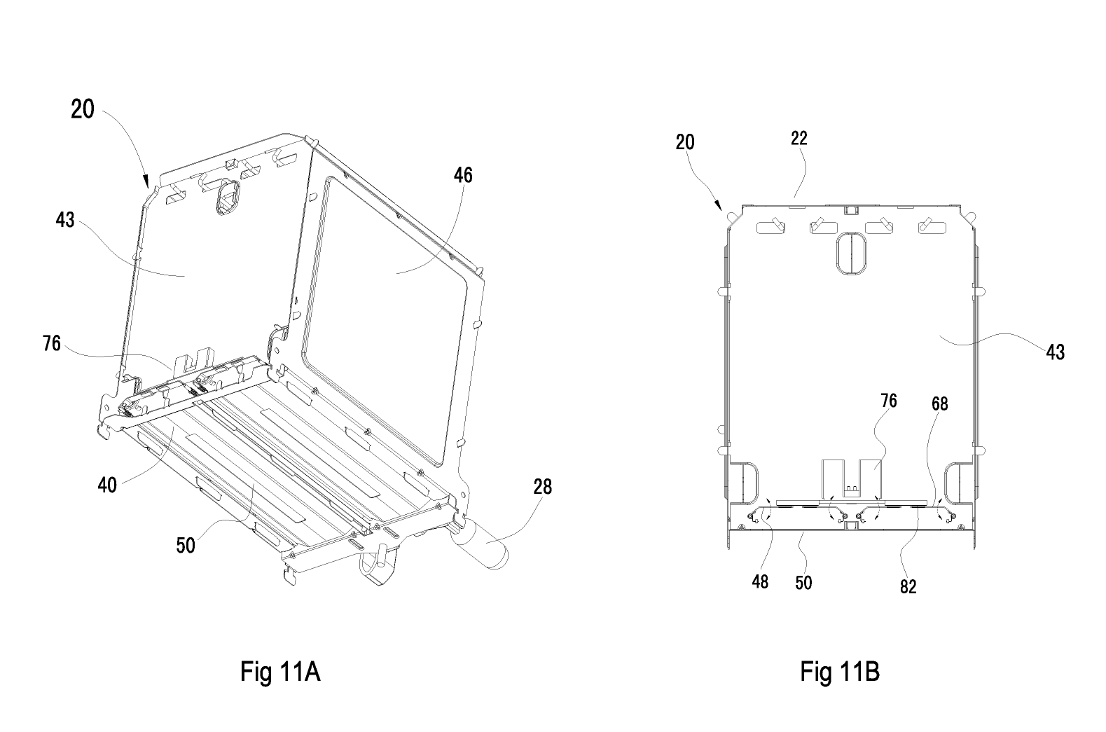

FIG. 11A is a perspective view showing the toasting unit of the second embodiment of FIG. 9 after loading of the food item (not shown);

FIG. 11B is a rear view showing the toasting unit of the second embodiment of FIG. 9 after loading of the food item (not shown);

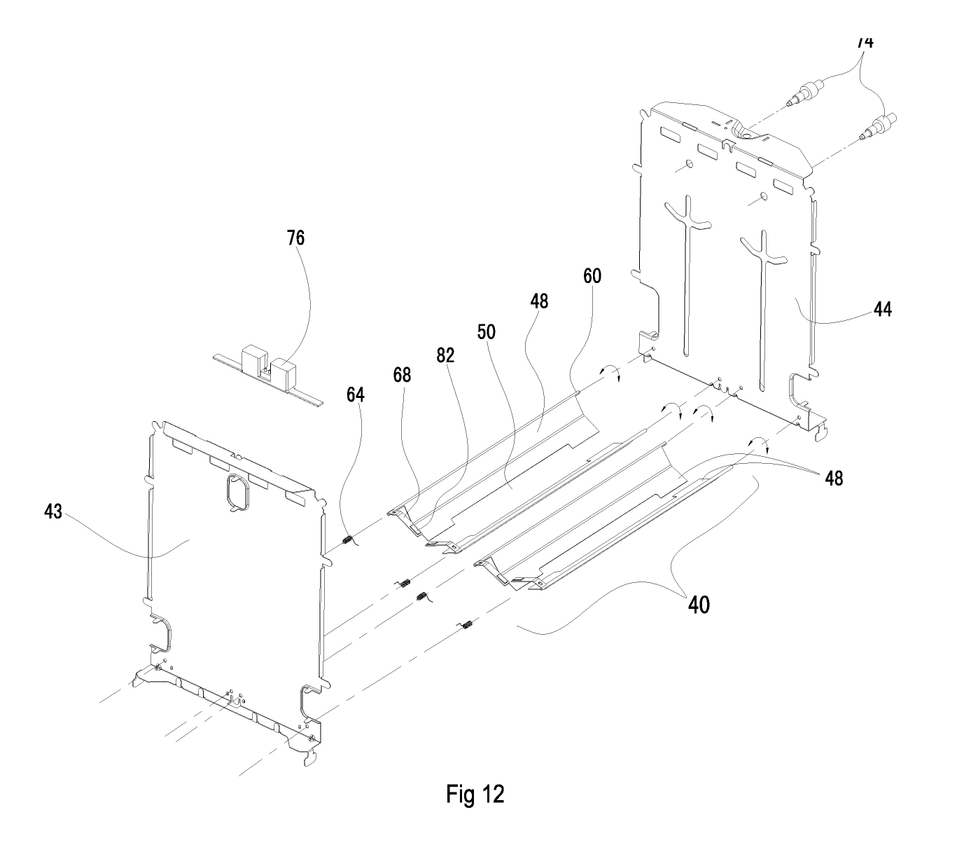

FIG. 12 is an exploded view showing the internal structures of the toasting unit as shown in FIGS. 10A and 11A;

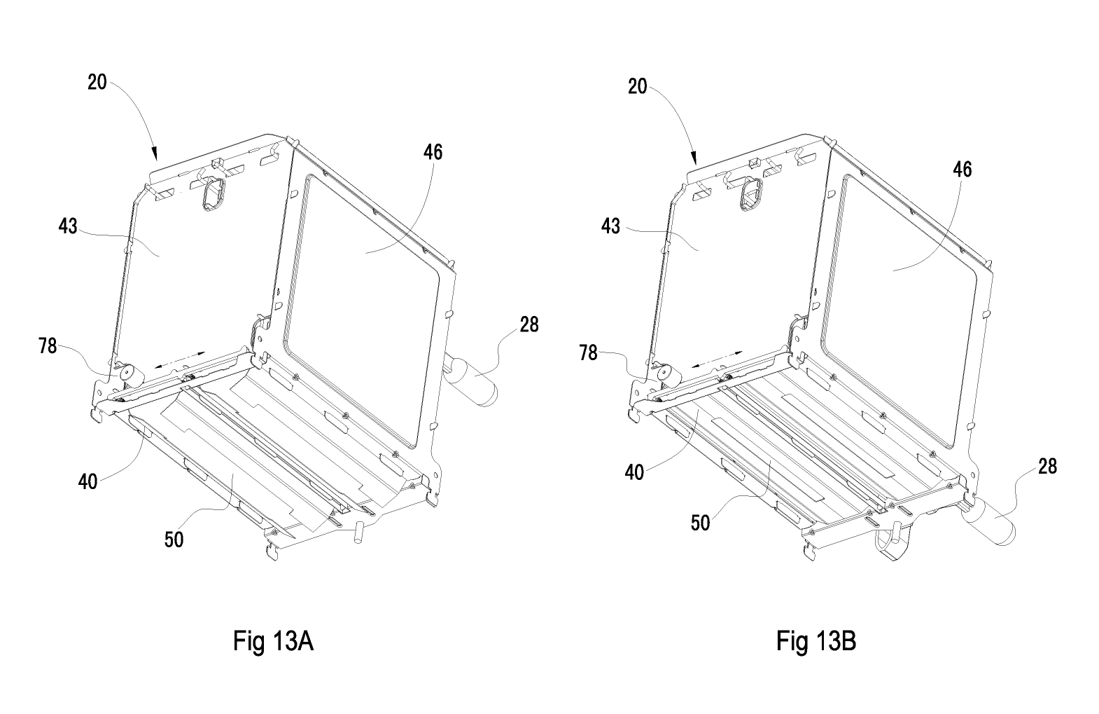

FIG. 13A is a perspective view showing the toasting unit of the third embodiment of FIG. 9 prior to the loading of the food item;

FIG. 13B is a perspective view showing the toasting unit of the third embodiment of FIG. 9 after loading of the food item (not shown);

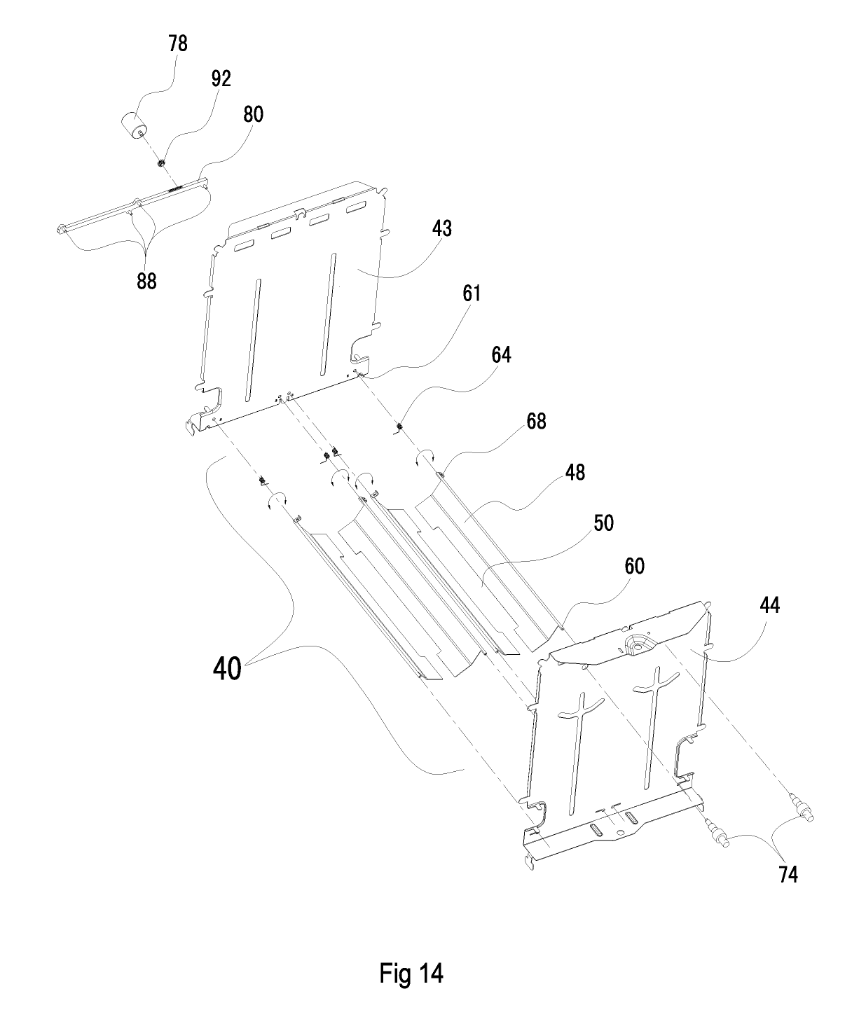

FIG. 14 is an exploded view showing the internal structures of the toasting unit as shown in FIGS. 13A and 13B;

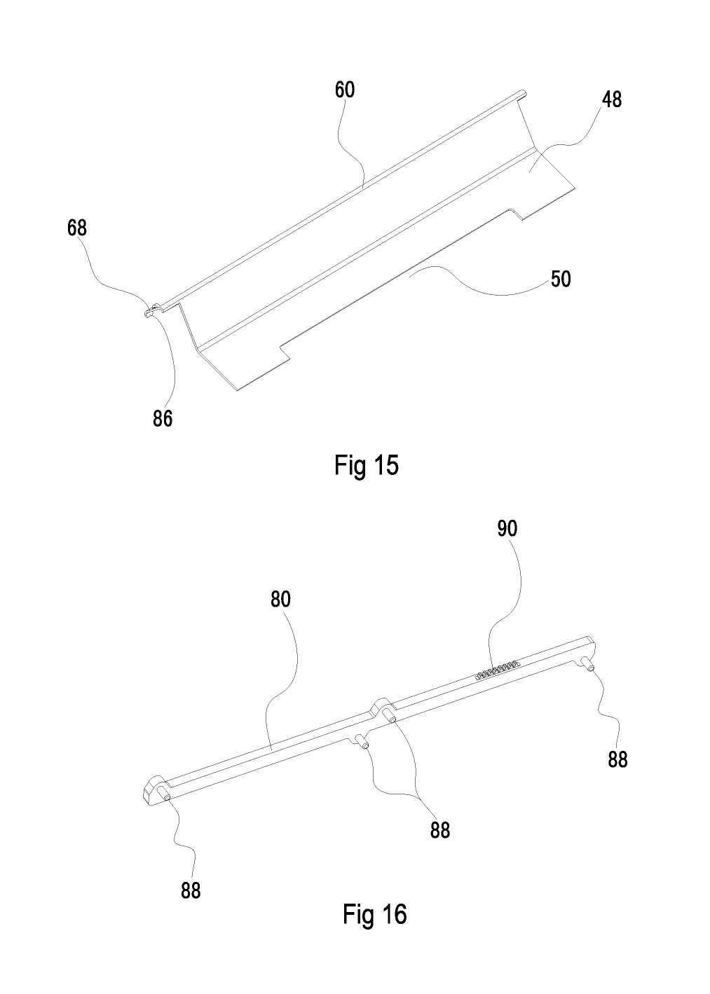

FIG. 15 is a perspective view showing a baffle of the first, second and third embodiments;

FIG. 16 is a perspective view showing a drive link as shown in FIGS. 13A, 13B and 14;

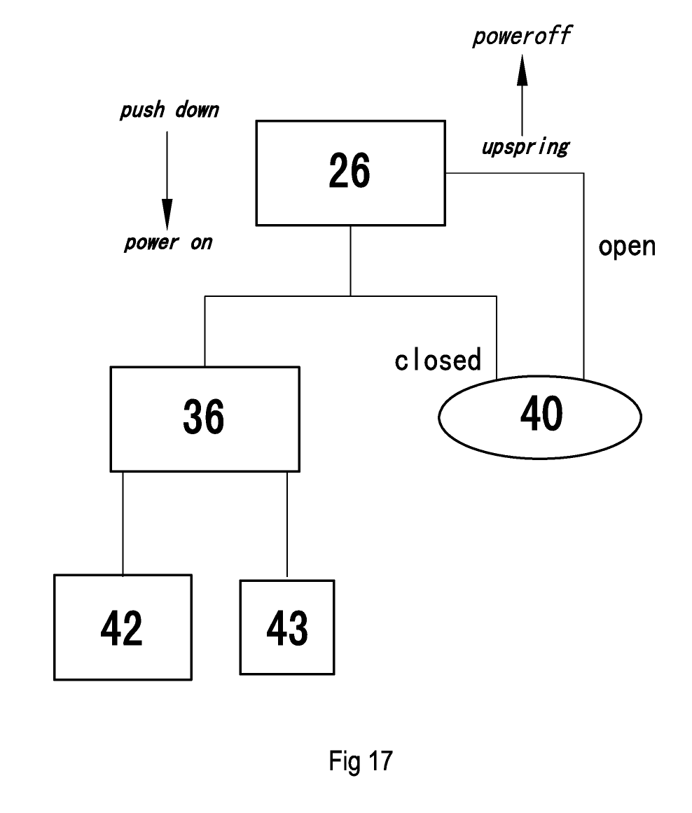

FIG. 17 is a block diagram showing the basic operations of a fourth embodiment of the present invention;

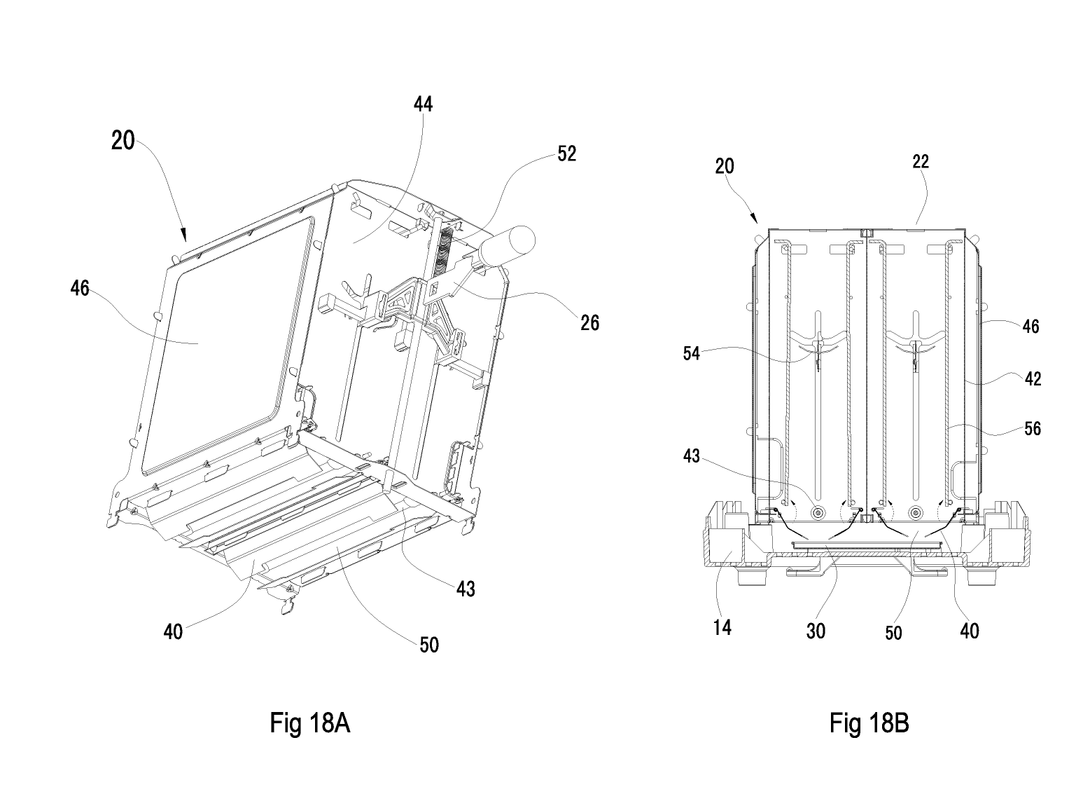

FIG. 18A is a perspective view showing the toasting unit of FIG. 17;

FIG. 18B is a front cross-sectional view showing the toasting unit of FIG. 17;

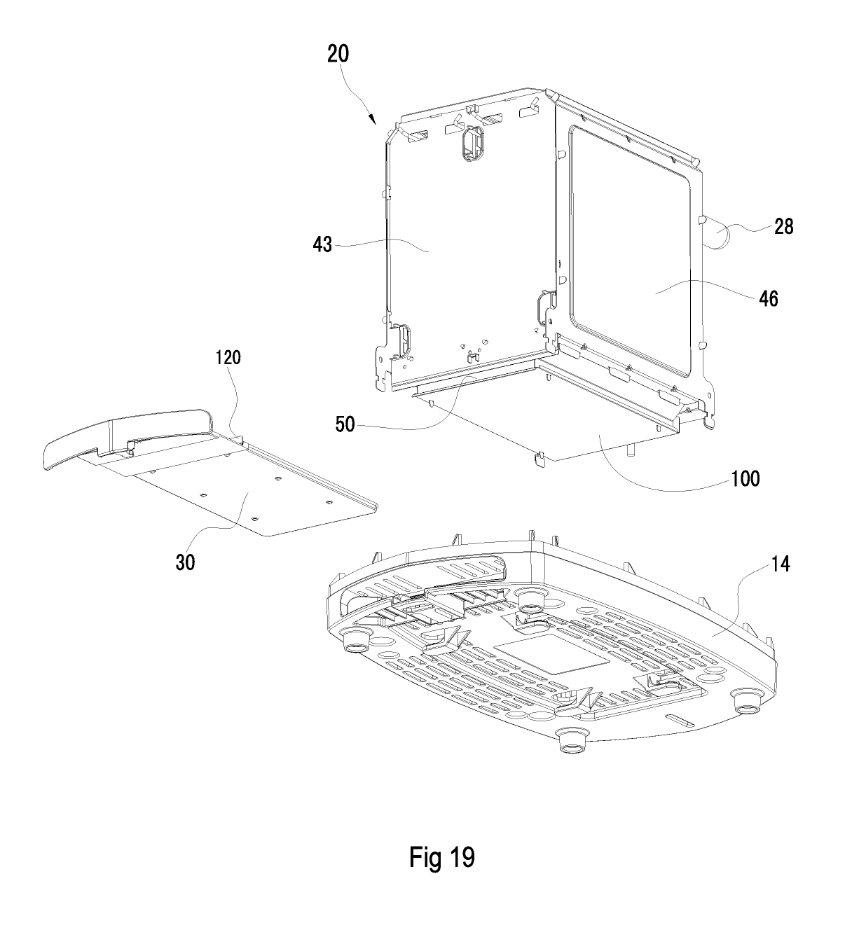

FIG. 19 is an exploded view showing a fifth embodiment of the present invention;

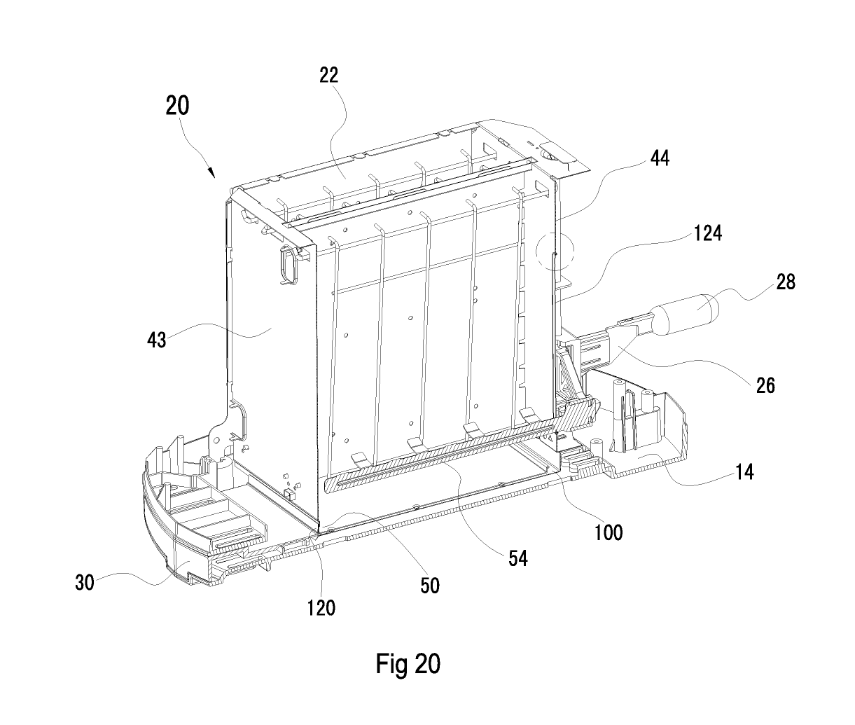

FIG. 20 is a side cross-sectional view showing the internal structures of the toasting unit of FIG. 19;

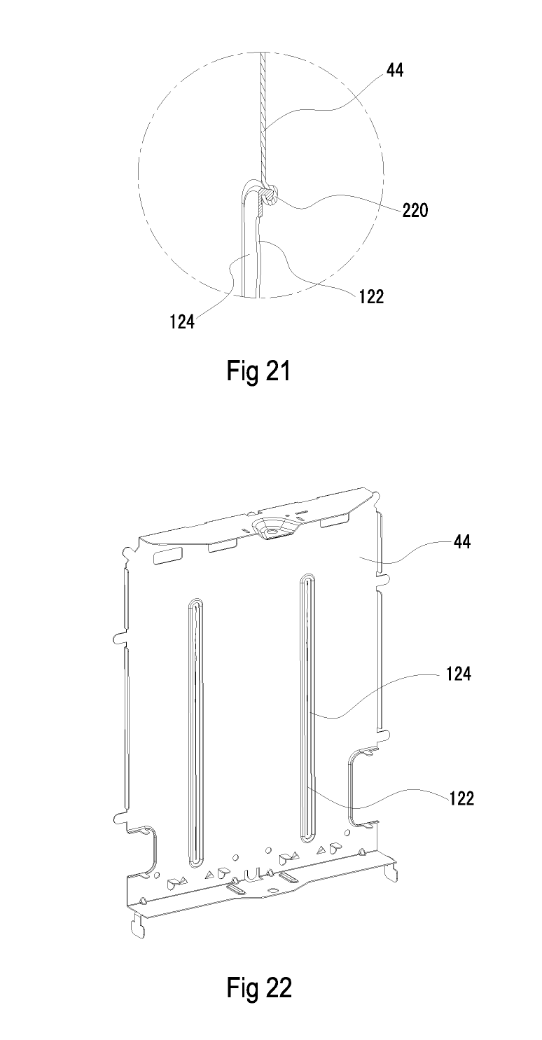

FIG. 21 is a magnified view of the front panel of the toasting unit of FIGS. 20; and

FIG. 22 is a perspective view showing the front panel of the toasting unit of FIG. 20.

### MODE FOR THE INVENTION

### Mode for Invention

The following description is of preferred embodiments by way of example only and without limitation to the combination of features necessary for carrying the invention into effect.

Reference in this specification to ‘one embodiment’ or ‘an embodiment’ means that a particular feature, structure, or characteristic described in connection with the embodiment is included in at least one embodiment of the invention. The appearances of the phrase ‘in one embodiment’ in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention provides a toaster for toasting a food item. The toaster comprises a chamber for receiving and accommodating the food item, a heating member for generating heat to toast the food item, and a control means for controlling air flow in the chamber to improve heat transfer onto the food item.

The invention is advantageous in that it provides a toaster which enables an improved heat transfer by directing, guiding or focusing the air flow which carries along the generated heat from the heating member onto the food item to be toasted, thereby improving the efficiency of the toaster. The toaster of the present invention allows toasting of the food item in a more controlled manner, thereby enabling the toasting be completed in a shorter period of time, and thus, with less energy consumption.

The food item herein described generally refers to bread in the form of bread slices.

Nevertheless, a person skilled in this technology field would appreciate that the present invention should not be limited to a toaster for heating bread slices only, but any other food items such as, but not limited to, muffins, bagels, cake slices, pastries, biscuits or waffles, may also be applicable, as long as the skilled person would consider it as suitable and appropriate.

FIG. 1 illustrates a first embodiment of the toaster of the present invention. As shown in the figure, toaster 10 comprises a housing 12 cooperatively connected with a base 14 adapted to encase a toasting unit 20, where a food item such as a bread slice is heated and toasted therein. The toasting unit 20 defines at least one chamber 24 for accommodating at least one slice of bread, which is received into the chamber 24 via an opening 22 of the chamber 24. The toasting unit 20 further comprises a loading means 26 operable by a user via a handle 28 to load the bread slice in, or to unload the bread slice from, the chamber 24.

In this embodiment, the toaster 10 comprises a tray 30 arranged at the bottom portion of the toasting unit 20. The tray 30 is adapted to collect any residues of the food item from falling into the base 14 which allows an easy cleaning after use. The tray 30 may also serve as a means 40 to control the air flow into the toasting unit 20 and to confine the volume of the chamber 24 so that convection heat transfer by the air flow and/or radiant heat can be directed, guided or focused onto the bread slice within the chamber 24. This facilitates a more controlled heat flow within the chamber 24 which allows the bread slice to be toasted more evenly and quickly, and thus assists in energy saving.

The housing 12 may further comprise a control panel having a plurality of switches, buttons 32 or knob 34 operable to actuate operation and/or control functionalities of the toaster 10. The control panel is electrically connected with a printed circuit board assembly (PCBA) 36 for processing operating instructions from the user. Although it is not shown in the figure, the PCBA 36 may also comprise a wireless module adapted to receive operating instructions from the user wirelessly, and to provide feedback to the user in a similar manner. The PCBA 36 may further comprise a communication module adapted to exchange information with the internet.

The basic operations of the toaster 10 can be illustrated by the block diagram of

FIG. 2. In use the loading means 26 can be pushed downward or lifted upward by the user to power on or off the toaster 10, respectively. Specifically, when the loading means 26 is arranged to move from an upper position to a lower position, an instruction will be sent to the PCBA 36 to actuate a heating member, which comprises a heating means 42, to generate the required heat for toasting the bread slice in the chamber 24. The control means 40 will also be closed simultaneously to control the air flow in the chamber thereby directing the generated heat onto the bread slice along with the air flow. On the other hand, when the loading means 26 is arranged to be lifted upward from the lower position, power to the toaster 10 will be cut off. Accordingly, no further heat will be generated by the heating means 42 and at the same time, the control means 40 will be opened to allow cooling down of the toasting unit 20. The lifting action of the loading means 26 can be done manually by the user when the user decides to stop the toasting process. Alternatively, the upward movement of the loading means 26 can be controlled by the PCBA 36 via a timer or a temperature sensor, so that the loading means 26 can be automatically restored to the upper position after a predetermined period of heating, or when it is detected that the chamber 24 has reached a certain, high temperature.

Structures of the toasting unit 20 can be more clearly shown in FIGS. 3A, 3B, 4A and 4B. Particularly, FIGS. 3A and 3B show the arrangement of the toasting unit 20 prior to the loading of a bread slice, and FIGS. 4A and 4B show the arrangement of the toasting unit 20 after loading of the bread slice (not shown). In this embodiment, the toasting unit 20 is in the form of a frame having a front panel 44, a rear panel (not shown), and a pair of opposite side panels 46. The toasting unit 20 also include a top portion having the opening 22, and a bottom portion where the control means 40 is located. In this specific embodiment, the control means 40 is in the form of a pair of movable baffles 48 with a slit at the center to define an air inlet 50. The size of the inlet 50 is adjustable based on the movement of the baffles 48, each of which is hingedly engaged with the chamber 24 at the bottom portion of the toasting unit 20. Prior to the loading of the bread slice, or after toasting that cooling to the toasting unit 20 is required, the baffles 48 are arranged to fan open downwardly and outwardly relative to the chamber 24 as shown in FIGS. 3A and 3B, thereby increasing the size of the inlet 50.

Although a toasting unit 20 with two chambers 24 and control means 40 having two baffles pairs 48 to define two inlets 50 for controlling air flow into the two respective chambers 24 are exemplified in FIGS. 3A and 3B, it is understandable that a toasting unit having only one chamber with a control means of one single pair of baffles; a control means with only one single baffle to define one single inlet relative to one chamber; or a control means having more than two baffles pairs for a toasting unit having more than two chambers, etc. may also be encompassed by the present invention.

After the bread slice is received into the chamber 24 via the opening 22, the handle 28 can be pushed downward by the user to allow the loading means 26 to resiliently move from the upper position to the lower position under the action of a resilient means 52 such as a spring. This simultaneously triggers a series of actions including lowering of a bread bracket 54 which supports the bread slice, engaging the bread slice by a retaining means 56 to secure the position of the bread within the chamber 24, actuating the heating means 42 to generate heat, and arranging the baffles pair 48 to move upwardly and inwardly relative to the chamber 24 thereby reducing the size of the open inlet 50 to the size of the slit. The slit comprises a narrow opening which extends longitudinally along a portion of the control means 40 to restrict the air flow into the chamber 24, thereby improving (in ways of directing, guiding or focusing) the heat transfer along with the air flow towards a central region of the chamber 24 where the bread slice is located. This assists in controlling the heat flow towards the bread slice to allow a more even toasting in a shorter period of time and thus, saving energy.

FIGS. 5 to 8 illustrate a number of relevant parts which involve in the actuation of the control means 40. FIG. 5 shows the connection arrangement among the front panel 44, the loading means 26 and the control means 40 of the toasting unit 20. In this embodiment, the control means 40 comprises a longitudinal shaft 60 where the baffle 48 is extended from. The shaft 60 defines a longitudinal axis about which the baffle is adapted to rotate. The two ends of the shaft 60 (i.e. the rear end and the front end) are adapted to engage two respective holes (i.e. rear hole 61 and front hole 62) at the rear panel 43 and the front panel 44, respectively. Particularly, a torsion spring 64 is provided at the engagement between the front end of the shaft 60 and the front hole 62 of the front panel 44, with an arm of the torsion spring 64 connected with a clasp 66 of the front panel 44. The front end of the shaft 60 further comprises a wing portion 68 protruding perpendicularly therefrom, which is adapted to be abutted by a linking block 70 of the loading means 26.

Upon actuation of the loading means 26 by pressing it downward by the user, the loading means 26 is adapted to slide down the rails 72 provided at the front panel 44, with the linking blocks 70 of the loading means 26 eventually reach the bottom of the rails and abut the corresponding wing portions 68 of the control means 40. The downward movement of the linking blocks 70 provides a torque to rotate the baffle 48 about the axis of the shaft 60, thereby arranging the baffles 48 to move outwardly and downwardly to open or to enlarge the inlets 50.

FIG. 9 is a block diagram showing the operations of a number of other embodiments of the present invention. In one embodiment, the PCBA 36 may comprise a temperature sensor or a timer 74 which is capable of sending instruction to turn on/off the heating means 42 automatically when the chamber 24 is detected to have reached a sufficiently high temperature, or after a predetermined period of heating. In further embodiments, movement of the control means 40 can be controlled by at least one of the action of an electromagnet 76, an electric motor 78 and/or a mechanical arrangement. In these embodiments, the angle of opening of the baffles 48 and thus the size of the inlet 50 can be adjusted by controlling the action of the electromagnet 76 and/or the electric motor 78 via the PCBA 36.

FIGS. 10A, 10B, 11A, 11B and 12 further illustrate another embodiment of the present invention in which the control means 40 are adapted to be movable by an electromagnet 76, which can be provided, for example, at or adjacent the rear panel 43 of the toasting unit 20. Specifically, FIGS. 10A and 10B show the toasting unit 20 prior to the loading of the bread slice, and FIGS. 11A and 11B show the toasting unit 20 after loading of the bread slice (not shown). In this embodiment, the wing portion 68 is provided at the rear end of the shaft 60 instead of the front end. Each wing portion 68 is further provided with an end plate 82 having a magnet or a metal material which is adapted to be attracted towards the electromagnet 76 when the electromagnet 76 is magnetized by an electric current. As shown in FIGS. 11A and 11B, when an electric current is allowed to pass through the electromagnet 76, a magnetic field will be generated to attract the end plate 82 towards the electromagnet 76. The wing portions 68 will move upward and inward relative to the chamber 24 subject to the magnetic attraction, thereby rotating the baffles 48 to close or to reduce the size of the inlets 50.

FIGS. 13A, 13B, 14 to 16 illustrate a further embodiment of the present invention in which the control means 40 are adapted to be movable by an electric motor 78, which can be provided at or adjacent the rear panel 43 of the toasting unit 20. Specifically, FIGS. 13A and 13B show the toasting unit 20 prior to and after the loading of the bread slice, respectively. In this embodiment, the wing portion 68 is again provided at the rear end of the shaft 60. The wing portion 68 may further comprises a catch member 86 adapted to engage a corresponding connecting means 88 of a drive link 80. As shown in FIG. 16, the drive link 80 may comprise a number of connecting means 88 protruding from the body of the drive link 80, and also a plurality of teeth member 90 adapted to engage the motor 78 via at least one gear member 92. When the motor 78 is powered on, the motor 78 will be arranged to rotate and drive the at least one gear member 92 to motion, which will subsequently translate in a side-way motion of the drive link 80. The connecting means 88 at the drive link 80, due to the movement of the drive link 80 relative to the rear panel 43, will be made to engage the catch member 86 of the wing portion 68 which provides the required torque to rotate the baffle about the axis of the shaft 60, thereby opening or closing the inlets 50. In this embodiment, the degree of movement of the drive link 80 can be controlled by the motor 78 which is in turn controlled by the PCBA 36, and therefore, angles of rotation of the baffles and thus the degrees of opening or closing of the inlets can be adjusted and varied.

FIGS. 17, 18A and 18B show another embodiment of the present invention in which the heating member comprises a first heating means 42 and a second heating means 43 arranged at different locations on the toasting unit 20. Particularly, the second heating means 43 can be arranged to operate simultaneously or sequentially with the first heating means 42. Preferably, the second heating means 43 is adapted to operate simultaneously with the first heating means 42, and subsequently switch off after a predetermined heating period. This may help equalizing the temperature difference at different regions within the chamber 24, and therefore assists in providing a more even heating over the bread slice within the toasting unit 20.

The toasting unit 20 as illustrated in FIGS. 18A and 18B is provided with similar features to those described in the earlier embodiments as shown in FIGS. 3A, 3B, 4A and 4B. In this embodiment, the toasting unit 20 further comprises the second heating means 43 in addition to the original, first heating means 42 which are generally arranged at or adjacent the side panel 46. Specifically, the second heating means 43 are positioned at the bottom portion of the toasting unit 20 adjacent the inlets 50. As mentioned earlier, the second heating means 43 are designed to operate simultaneously with the first heating means 42 when the toaster 10 is just switched on to toast a bread slice. After a predetermined period of time after the switching on of the toaster 10, the second heating means 43 will be switched off automatically, but the first heating means 42 will continue to operate until the bread slice is sufficiently toasted. This arrangement allows the temperature within the chamber 24 be rapidly equalized after the toaster 10 is switched on, and thereby enabling the bread slice to be more evenly toasted in a shorter period of time.

In yet a further embodiment, there is provided a toasting unit 20 having the control means 40 be arranged in the form of a plate 100. The plate 100 can be fixedly positioned at the bottom portion of the toasting unit 20, or alternatively, be arranged to slidably movable relative to the chamber 24. As shown in FIGS. 19 and 20, the plate 100 can be positioned above the tray 30 at the bottom portion of the toasting unit 20. Specifically, the plate 100 can be configured with baffle walls at the rear end and the opposite sides, and an opened front end to define the inlet 50. In one embodiment, the baffle walls of the plate 100 can be arranged to be substantially sealingly engaged with the toasting unit 20, so that air flow into the chamber 24 is restricted via the inlet 50 at the opened front end only. Preferably, the inlet 50 can further be selectively closed by a sealing means 120 arranged at, for example, the tray 30, when the tray 30 is manually inserted at the bottom portion of the toasting unit 20. When the inlet 50 being closed by the sealing means 120, the bottom portion can be made substantially air tight. Alternatively, if ventilation to the chamber 24 from the bottom is desired, the user may re-open the inlet 50 easily by sliding the tray 30 away from the toasting unit 20. In another embodiment, the sealing means 120 may also be arranged at the control means 40 at various configurations to seal the inlet 50, as long as it is considered applicable and reasonable for the specific requirements.

To further improve the earlier embodiment, air-tight junctions can be arranged between the loading means 26 and the front panel 44 by, for example, providing a sealing member in the form of sealing strips 124 to substantially seal the rails 72 at the front panel 44. As shown in FIGS. 20 to 22, the front panel 44 can be configured with a flange 220 adapted to sealingly engage a sealing strip 124 for substantially sealing the rail 72 but at the same time, providing a groove 122 for the up and down sliding movement of the loading means 26 along the rail 72.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word ‘comprise’ or variations such as ‘comprises’ or ‘comprising’ is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A toaster, comprising:
a chamber for receiving and accommodating a food item,
a heating member for generating heat to toast the food item, and
a control means for controlling air flow in the chamber to improve heat transfer onto the food item.

2. The toaster according to claim 1, wherein the control means is arranged to guide the air flow towards the food item accommodated in the chamber.

3. The toaster according to claim 1, wherein the control means is arranged to guide the air flow towards a central region of the chamber.

4. The toaster according to claim 1, wherein the control means defines an air inlet.

5. The toaster according to claim 4, wherein the control means is movably engageable with the chamber to define the air inlet.

6. The toaster according to claim 5, wherein the control means comprises at least one baffle movable relative to the chamber to adjust size of the air inlet.

7. The toaster according to claim 6, wherein the control means comprises at least one pair of baffles movable relative to each other to adjust the size of the air inlet.

8. The toaster according to claim 5, wherein the control means is hingedly engaged with the chamber.

9. The toaster according to claim 1, wherein the control means is arranged adjacent to a bottom portion of the chamber.

10. The toaster according to claim 4, wherein the air inlet is defined by a slit arranged at the control means.

11. The toaster according to claim 1, wherein the control means is movable by means comprises at least one of an electromagnet, an electric motor or a mechanical arrangement.

12. The toaster according to claim 1, wherein the control means comprises a plate slidably movable relative to the chamber.

13. The toaster according to claim 4, wherein the air inlet is adapted to be substantially sealed by a sealing means.

14. The toaster according to claim 13, wherein the sealing means is arranged at the control means.

15. The toaster according to claim 1, wherein the heating member comprises at least a first heating means and a second heating means, the second heating means is adapted to operate simultaneously or sequentially with the first heating means.

16. The toaster according to claim 15, wherein the second heating means is adapted to operate simultaneously with the first heating means, and subsequently switch off after a predetermined heating period.
